(19) United States
(12) Patent Application Publication
(10) Pub. No.: US 2026/0084301 A1
(43) Pub. Date: Mar. 26, 2026

(54) POSITION CONTROL DEVICE

(71) Applicant: OKUMA Corporation, Niwa-gun (JP)

(72) Inventor: Satoshi EGUCHI, Niwa-gun (JP)

(21) Appl. No.: 19/338,224

(22) Filed: Sep. 24, 2025

(30) Foreign Application Priority Data
Sep. 25, 2024 (JP) 2024-166699

(51) Int. Cl. B25J 9/16; B25J 9/12

(52) U.S. Cl. CPC B25J 9/1641; B25J 9/12

(57) ABSTRACT

A position control device for a target plant includes a coefficient calculation unit that performs temporary operation of the target plant so as to reverse a direction of travel of the target plant with backlash compensation turned off and calculates a coefficient for reverse detection for each of a plurality of backlash portions, based on a position command value at a timing when a position deviation between a position detection value for a load end and the position command value increases rapidly, a reverse detection unit that operates the target plant with the backlash compensation turned on and detects a timing when a load-side transmission torque is reversed, based on the coefficient, the position command value, and a moment of inertia of the entire load, and a compensation value calculation unit that increases or decreases a backlash compensation value at the timing when reverse is detected.

### CROSS REFERENCE TO RELATED APPLICATION

This application claims priority to Japanese Patent Application No. 2024-166699 filed on Sep. 25, 2024, which is incorporated herein by reference in their entireties including the specifications, claims, drawings, and abstracts.

### TECHNICAL FIELD

The present description discloses a position control device for a target plant in which a torque transmission path extending from a motor has a backlash portion.

### BACKGROUND

Position control devices that control a motor such that a position of a target plant (hereinafter referred to as a “load position”) follows a position command value have been widely known. Such position control devices are applied, for example, to axis control of numerical control machines.

The position control devices may have a backlash portion in a torque transmission path between the motor and the target plant. The backlash portion is a gap or deflection between torque transmission components. This backlash portion becomes a dead zone where torque is not transmitted temporarily while the direction of motion is being reversed. This backlash portion causes a command-following error.

In light of the above, techniques for reducing command-following errors caused by the backlash portion have been proposed. For example, Patent Document 1 discloses a correction device that corrects backlashes between a driving gear and a driven gear. The correction device calculates a transmission torque applied from the driving gear to the driven gear based on position command information. When the sign of this transmission torque is reversed, the correction device determines that a backlash has occurred and corrects a command value to correct the backlash. This technique makes it possible to reduce the command-following errors caused by the backlashes to some extent.

### CITATION LIST

### Patent Literature

Patent Document 1: JP 2002-366230 A

The torque transmission path may have more than one backlash portion depending on its configuration. The prior art devices, such as that disclosed in Patent Document 1, cannot handle the case where the torque transmission path includes a plurality of backlash portions. As a result, in the prior art devices, command-following performance is deteriorated when the torque transmission path includes a plurality of backlash portions.

In consideration of the above, the present description discloses a position control device that can maintain high command-following performance even when the torque transmission path includes a plurality of backlash portions.

### SUMMARY

The present description discloses a position control device for a target plant in which a motor and a load end are connected via a torque transmission path having a plurality of backlash portions. The position control device includes a coefficient calculation unit that performs temporary operation of the target plant so as to reverse a direction of travel of the target plant with backlash compensation turned off and calculates a coefficient for reverse detection for each of the plurality of backlash portions, based on a position command value at a timing when a position deviation between a position detection value at the load end and the position command value increases rapidly, or based on a velocity command value and acceleration command value at the timing when the position deviation increases rapidly, a reverse detection unit that operates the target plant with the backlash compensation turned on and detects a timing when a load-side transmission torque is reversed for each of the plurality of backlash portions, based on the coefficient for reverse detection, the position command value, and a moment of inertia of the entire load; a compensation value calculation unit that increases or decreases a backlash compensation value at the timing when the load-side transmission torque is reversed, and a position control loop unit that controls a position of the motor such that the position detection value at the load end becomes a position command value compensated with the backlash compensation value.

In this case, the compensation value calculation unit may add or subtract the amount of backlash of the k-th backlash portion from the motor, to or from a current backlash compensation value at a timing when the load-side transmission torque is reversed at the k-th backlash portion.

The position control loop unit may control the position of the motor such that an absolute value of a position error that is a difference between the compensated position command value and a position feedback value becomes smaller, and the position feedback value may include a sum of the position detection value at the load end and the backlash compensation value.

The position command value in the temporary operation indicates a sinusoidal waveform represented by X=X₀+R₀*sin θ, and the coefficient calculation unit may calculate a coefficient Mₖ corresponding to the k-th backlash portion from the motor, based on Mₖ=(sin θ₁/sin θₖ)*J_{L}, where θₖ is θ obtained when the position deviation increases rapidly due to the k-th backlash portion, and J_{L} is the moment of inertia of the entire load.

The compensation value calculation unit may calculate the load-side transmission torque in the k-th backlash portion τ_{Lk} based on the equation τ_{Lk}=Mₖ*A+τ_{F}, where τ_{Lk} is the load-side transmission torque in the k-th backlash portion, τ_{F} is a sliding friction torque, and A is an acceleration command value.

The position command value in the temporary operation indicates a sinusoidal waveform represented by X=X₀+R₀*sin θ, and the coefficient calculation unit may calculate a coefficient Nₖ corresponding to the k-th backlash portion from the motor, based on the equation Nₖ=sgn(Vₖ)/Aₖ, where Aₖ is an acceleration command value when the position deviation increases rapidly due to the k-th backlash portion.

The compensation value calculation unit may calculate a determination parameter r_{Lk} based on the equation r_{Lk}=−A*Nₖ+sgn(V), where V is a velocity command value, A is an acceleration command value, and sgn is a sign function, and detect a timing when positive and negative of the determination parameter r_{Lk} is reversed as a timing when the load-side transmission torque is reversed at the k-th backlash portion.

According to the technique disclosed in the present description, even when the torque transmission path includes a plurality of backlash portions, high command-following performance can be maintained.

### BRIEF DESCRIPTION OF DRAWINGS

Embodiments of the present disclosure will be described based on the following figures, wherein:

FIG. 1 is a block diagram showing a configuration of a position control device;

FIG. 2 is a schematic diagram of a target plant;

FIG. 3 is a diagram showing an example of changes in a position command value, an acceleration command value, and sliding friction torque;

FIG. 4 is a diagram showing changes in a position command value, torque, and position deviation in the range Sa in FIG. 3;

FIG. 5 is a schematic diagram of a target plant with a single backlash portion;

FIG. 6 is a diagram showing changes in a position command value and torque in the target plant in FIG. 5; and

FIG. 7 is a block diagram showing another example of the position control device.

### DESCRIPTION OF EMBODIMENTS

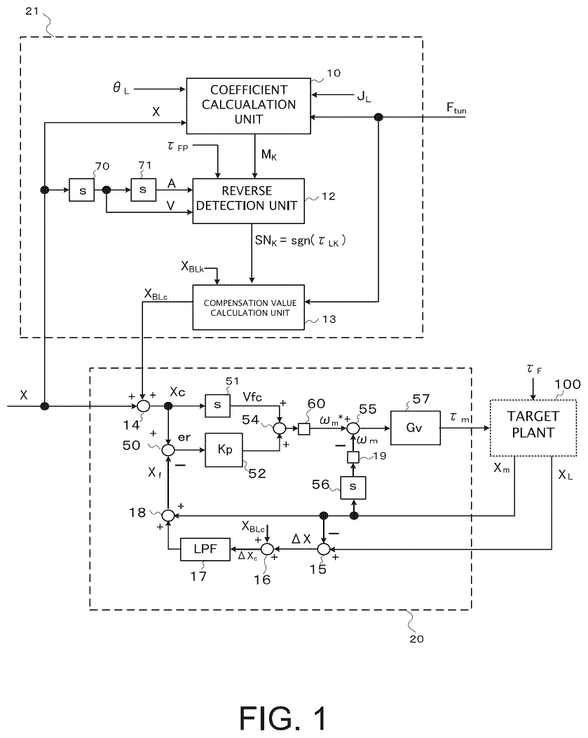

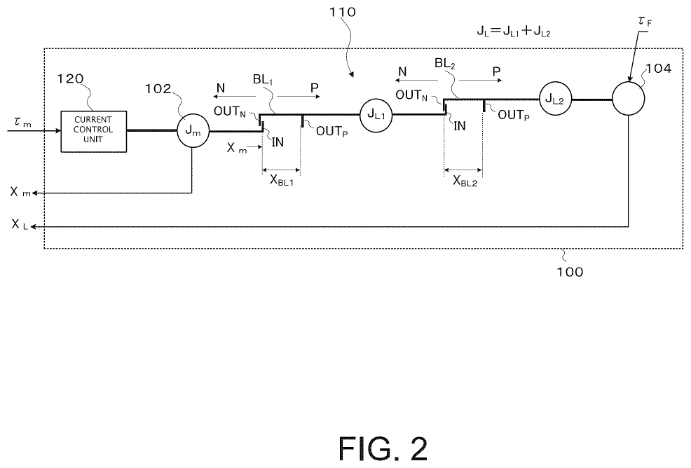

Hereinafter, a configuration of a position control device will be described with reference to the drawings. FIG. 1 is a block diagram showing a configuration of a position control device. FIG. 2 is a schematic diagram of a target plant 100. As shown in FIG. 2, the target plant 100 has a motor 102, a torque transmission path 110, a load end 104, and a current control unit 120. Torque output from the motor 102 is transmitted to the load end 104 via the torque transmission path 110. The position control device calculates a torque command value τₘ for the motor 102, in order to control a position X_{L} of the load end 104 in accordance with a position command value X instructed from a superior device (not shown). The current control unit 120 applies a current corresponding to the torque command value τₘ to the motor 102. The current control unit 120 may include an inverter, for example. Such a position control device may be applied to axis control of numerical control machines (e.g., machine tools) or robots and is thus required to have system stability and high command-following performance.

As shown in FIG. 2, the torque transmission path 110 of the target plant 100 includes a plurality of (two in the illustrated example) backlash portions BL₁ and BL₂. Hereinafter, when it is not necessary to distinguish between the plurality of backlash portions BL₁ and BL₂, the subscripts will be omitted, and the plurality of backlash portions will be simply referred to as the “backlash portions BL”. Additionally, the k-th backlash portion from the motor 102 will be denoted as “backlash portion BLₖ”. The same applies to other elements.

The backlash portion BL is a portion where a gap or deflection is generated when the driving direction is reversed. The amount of backlash X_{BLk} is the amount of gap or deflection in each backlash portion BLₖ. The presence of such a backlash portion BL causes a dead band where motion is not transmitted to the load side temporarily while the driving direction is being reversed, i.e., backlash. The occurrence of backlash causes a command-following error. To illustrate this phenomenon, FIG. 2 shows a model composed solely of the inertial moment J_{Lk} and the backlash portion BLₖ.

As described above, the position control device in this example is used for axis control of the numerical control machines or robots. Typically, the axis to be controlled is connected to a first load end that is driven in the first axis direction and a second load end that is driven in the second axis direction. The first load end and the second load end are then driven in a sinusoidal waveform with a phase difference of 90 degrees from each other, to thereby drive the axis to be controlled in an arc shape. As an example, the case where the load end 104 is driven in a sinusoidal waveform to drive the axis to be controlled in an arc shape will be described. To drive the load end 104 in a sinusoidal waveform, the position command value X is expressed as shown in Equation 1, where R₀ is the radius of the arc, X₀ is an offset from the center of the arc, ω₀ is the angular velocity, and t is time.

$$\begin{matrix}X = {X}_{0} + {R}_{0} * sin ( {ω}_{0} t ) \\ = {X}_{0} + {R}_{0} * sin θ\end{matrix} \qquad Equation 1$$

The position control device is a computer physically including a processor and a memory. Such a position control device may be configured, for example, by combining a plurality of physically separate computers. The position control device may also be configured, for example, as a numerical control device.

In terms of functionality, the position control device is roughly divided into a position control loop unit 20 that calculates the torque command value τₘ and a backlash compensation unit 21 that compensates for backlash, as shown in FIG. 1. The position control loop unit 20 receives the position command value X from the superior device. The position control loop unit 20 also receives a load position detection value X_{L} and a motor position detection value Xₘ. The load position detection value X_{L} is a position detection signal provided at the load end 104. The motor position detection value Xₘ is a signal obtained by converting a signal from a rotation angle detector installed on the motor 102 into a linear distance.

The position command value X is compensated by adding a backlash compensation value X_{BLc} output from the backlash compensation unit 21. The compensated position command value X_{c} is time-differentiated by a differentiator 51, to thereby form a velocity feedforward amount V_{fc}. In addition, a subtracter 50 subtracts a position feedback value X_{f} from the compensated position command value X_{c} and outputs a position error er. The calculation of the position feedback value X_{f} will be described below. A position error amplifier 52 amplifies the position error er by a factor of a position loop gain Kp. The outputs from the differentiator 51 and the position error amplifier 52 are added together in an adder 54 to form a velocity command. A converter 60 converts this velocity command into angular velocity and outputs the resulting angular velocity command value ωₘ*.

The motor position detection value Xₘ is time-differentiated by a differentiator 56, and then the resulting value is converted into motor velocity ωₘ by a converter 19. A subtracter 55 subtracts the motor velocity ωₘ from the velocity command value ωₘ* and outputs a velocity error. The velocity error is amplified by a velocity error amplifier 57 by a factor of Gv (generally, a proportional-integral amplifier is used), and the resulting value is output as a torque command value τₘ.

The position feedback value X_{f} is a value obtained by compensating the detection value deviation ΔX, which is calculated by subtracting the motor position detection value Xₘ from the load position detection value X_{L}, with the backlash compensation value X_{BLc}. More specifically, the detection value deviation ΔX is calculated by subtracting the motor position detection value Xₘ from the load position detection value X_{L}. The backlash compensation value X_{BLc} is then added to this detection value deviation ΔX. The resulting value is subjected to low-pass filtering by an LPF processing unit 17. An output value from the LPF processing unit 17 is then added to the motor position detection value Xₘ, to thereby form the position feedback value X_{f}. The reason for calculating the position feedback value X_{f} in this manner will be described below.

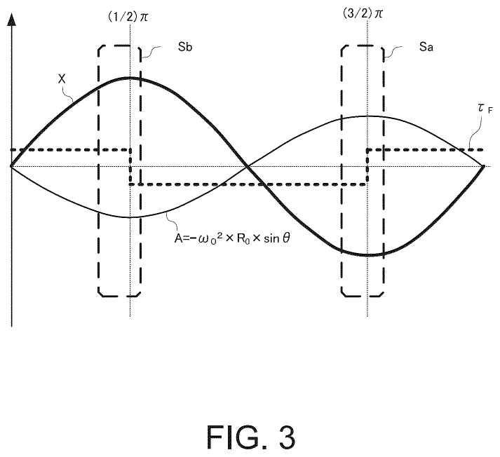

Next, the backlash compensation unit 21 will be described. Prior to describing the configuration of the backlash compensation unit 21 in detail, the behavior of the target plant 100 during the reversal of the driving direction will be described. FIG. 3 is a diagram showing an example of changes in the position command value X, an acceleration command value A, and sliding friction torque τ_{F}.

As described above, in this example, the position command value X=X₀+R₀*sin(θ) for a sinusoidal motion is used as an input. In this case, the driving direction is reversed at the timing when θ=½π and θ=3/2π. Additionally, the acceleration command value A is obtained by differentiating the position command value X twice. The acceleration command value A has a waveform with a phase difference of π with respect to the position command value X. The sliding friction torque τ_{F} is sliding friction torque required to drive the load.

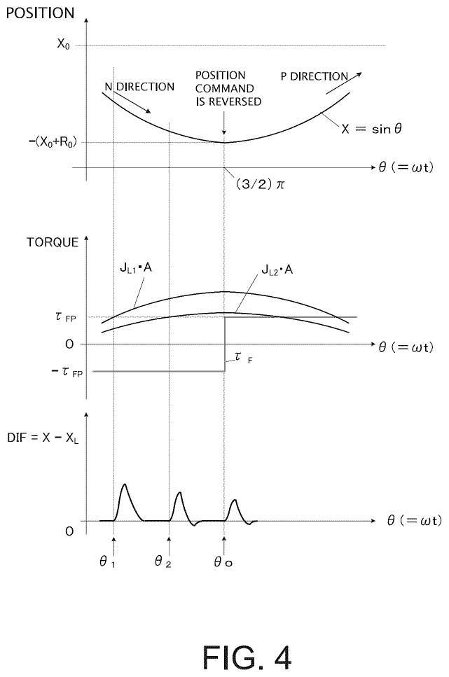

In this case, backlash occurs in ranges Sa and Sb that are respectively around ½π and 3/2π. Changes in load-side transmission torque τ_{Lk} in the range Sa will be described with reference to FIG. 4 to FIG. 6.

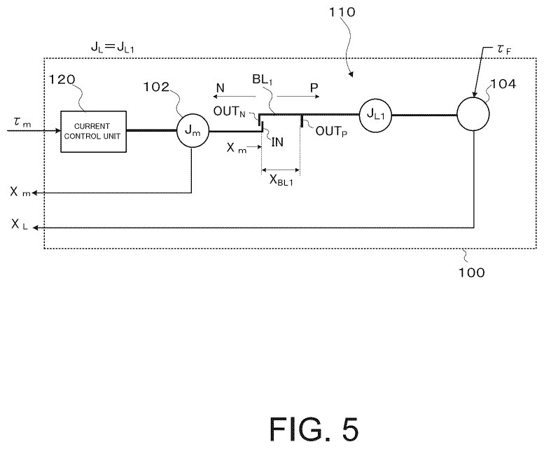

First, the case where the torque transmission path 110 includes a single backlash portion BL₁ in, as shown in FIG. 5 will be considered. In FIG. 5, Jₘ indicates the inertial moment of the motor 102, and J_{L1} indicates the inertial moment from the backlash portion BL₁ to the load end 104. In the example of FIG. 5, J_{L1} is equal to the total inertial moment J_{L} which is the moment of inertia of the entire load. In addition, the load end 104 is subjected to the sliding friction torque τ_{F} when the load end 104 is moved. Hereinafter, the left direction of the paper plane will be referred to as the “N direction” and the right direction of the paper plane will be referred to as the “P direction”.

The backlash portion BL₁ has an output terminal OUT_{N} on the N direction side and an output terminal OUT_{P} on the P direction side. In the example shown in FIG. 5, the input terminal IN is in contact with the output terminal OUT_{N}, while it is separated from the output terminal OUT_{P}. In the state shown in FIG. 5, when the load end 104 moves in the N direction, the load position detection value X_{L} coincides with the motor position detection value Xₘ, and X_{L}=Xₘ holds true. On the other hand, when the moving direction is reversed, and the load end 104 moves in the P direction, the motor 102 needs to operate excessively by the amount of backlash X_{BL1}. That is, it is necessary that X_{L}=Xₘ+X_{BL1}.

To this end, the velocity feedforward amount V_{fc} is compensated by the backlash velocity V_{BL} at the timing when the direction of travel of the position command value X is reversed. The backlash velocity V_{BL} is, for example, an impulse responsive time function expressed as V_{BL}=V_{BL0}*e^{-t÷T}, where T is a time constant, and its area corresponds to the amount of backlash X_{BL1}. This backlash velocity V_{BL} may be added or subtracted to or from the velocity feedforward amount V_{fc} when the direction of travel is reversed, depending on the direction of reversal.

However, in order to maintain high following performance even after the direction of travel is reversed, it is necessary to quickly execute motor operation equivalent to the amount of backlash X_{BL1} at the timing when the load-side transmission torque τ_{L1} is reversed. The load-side transmission torque τ_{L1} is the torque transmitted from the backlash portion B_{L1} to the load side. The load-side transmission torque τ_{L1} is expressed by Equation 2 below, where the acceleration command value A is a second-order differential value of the position command value X.

$${τ}_{L 1} = {J}_{L 1} * A + {τ}_{F} \qquad Equation 2$$

The absolute value of the sliding friction torque τ_{F} is constant regardless of the velocity, and the sign of the sliding friction torque τ_{F} is reversed when the direction of travel is changed between the P direction and the N direction. That is, the sliding friction torque τ_{F} is expressed by Equation 3. In Equation 3, τ_{FP} is a predetermined fixed value, and sgn(i) is a sign function. The sign function is a function that outputs 1 when the argument i is positive, outputs −1 when the argument i is negative, and outputs 0 when the argument i is 0.

$${τ}_{F} = sgn ( V ) * {τ}_{F P} \qquad Equation 3$$

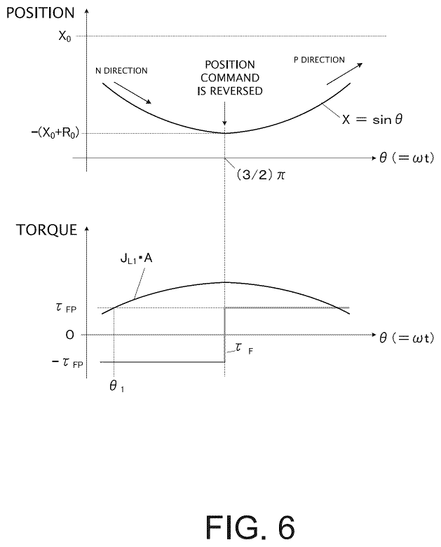

In order to maintain high following performance, it is necessary to compensate the command value in accordance with the state of the load-side transmission torque τ_{L1} expressed by Equation 2. FIG. 6 is a schematic diagram showing changes in the position command value X and the torque in the target plant 100 in FIG. 5. In the example of FIG. 6, θ₁ at which τ_{F}=J_{L1}*A holds true is the timing at which the load-side transmission torque τ_{L1} is reversed.

Here, when there is a single backlash portion BL, J_{L}=J_{L1} holds true. In addition, the total inertial moment J_{L} can be easily identified online from the inertial moment Jₘ (constant value) of the motor and real-time acceleration/deceleration characteristics. Furthermore, the sliding friction torque τ_{F} is measured or identified in advance. Therefore, when there is a single backlash portion BL, the state of the load-side transmission torque τ_{L1} can be easily determined from the total inertial moment of the load J_{L}, the acceleration command value A, and the sliding friction torque τ_{F}.

On the other hand, as shown in FIG. 2, when the torque transmission path 110 includes the plurality of backlash portions BL₁ and BL₂, it is necessary to determine the state of the load-side transmission torques τ_{L1} and τ_{L2} for the backlash portions BL₁ and BL₂, respectively and change the backlash compensation value X_{BLc} according to the respective determination results. In other words, when the torque transmission path 110 includes the plurality of backlash portions, monitoring the load-side transmission torque τ_{L1} of one backlash portion BL₁, which is obtained by the above Equation 2, is not sufficient to calculate an appropriate backlash compensation value X_{BLc}. As a result, it is not possible to maintain high command-following performance. To address this, in this example, the state of the load-side transmission torque τ_{Lk} is determined for each of the plurality of backlash portions BLₖ. The principle of backlash compensation in this example will now be described.

First, the case where the torque transmission path 110 includes the plurality of backlash portions BL₁ and BL₂ will be described with reference to FIG. 2. Although FIG. 2 shows the only two backlash portions BL, the following description will be given on the assumption that there are n backlash portions BL. In addition, the inertial moment between the k-th backlash portion BLₖ which is the k-th backlash portion from the motor and the next backlash portion BLₖ₊₁ (or the load end 104 if there is no backlash portion BLₖ₊₁) is referred to as the “k-th partial inertial moment J_{Lk}”. The torque transmitted from the k-th backlash portion BLₖ to the load side is referred to as the “k-th load-side transmission torque τ_{Lk}”. The sliding friction torque τ_{F} for moving the load is assumed to be always the sliding friction torque for the load end 104.

The k-th load-side transmission torque τ_{Lk} can be expressed by Equations 4 and 5 below.

$${τ}_{L k} = {M}_{k} * A + {τ}_{F} \qquad Equation 4$$

$${M}_{k} = {J}_{L k} + {J}_{L k + 1} + … + {J}_{Ln} \qquad Equation 5$$

Therefore, in the example shown in FIG. 2, the first load-side transmission torque τ_{L1} and the second load-side transmission torque τ_{L2} are respectively given by Equations 6 and 7.

$$\begin{matrix}{τ}_{L 1} = ( {J}_{L 1} + {J}_{L 2} ) * A + {τ}_{F} \\ = {J}_{L} * A + {τ}_{F}\end{matrix} \qquad Equation 6$$

$${τ}_{L 2} = {J}_{L 2} * A + {τ}_{F} \qquad Equation 7$$

Next, there will be considered the case where the position command value X indicating a sinusoidal waveform is input with the backlash compensation value X_{BLc} set to 0 (that is, with backlash compensation turned OFF). In this case, the position command value X is expressed as X=X₀+R₀*sin θ. Here, when θ is less than θ₁ in FIG. 4, the position command value X indicates travel in the N direction, but the first load-side transmission torque τL₁ is less than 0. Therefore, the input terminal IN of the first backlash portion BL₁ comes into contact with the output terminal OUT_{N} on the N direction side. That is, the gap X_{S1} between the input terminal IN and the output terminal OUT_{N} becomes 0.

Subsequently, when θ>θ₁, the first load-side transmission torque τ_{L1}>0. The motor 102 thus operates excessively such that the input terminal IN moves toward the output terminal OUT_{P} on the P direction side. Here, when the gap X_{S1} is less than the amount of backlash X_{BL1}, the torque is not transmitted to the end side of the first backlash portion BL₁. This results in insufficient deceleration torque, and the load position detection value X_{L} overshoots on the N direction side of the position command value X. Consequently, as shown in the third row of FIG. 4, a position deviation DIF=X−X_{L} increases rapidly immediately after the angle θ₁.

Similarly, for the second backlash portion BL₂, the position deviation DIF also increases rapidly immediately after the angle θ₂ at which the second load-side transmission torque τ_{L2} is reversed from negative to positive. The rapid increase in the position deviation DIF at θ_{O} in FIG. 4 is a delay in following a sudden change in the sliding friction torque τ_{F}, and is not a delay caused by the backlash.

To reduce the rapid increase in the position deviation DIF caused by the backlash, the backlash compensation value X_{BLc} to be added to the position command value X is increased or decreased by the amount of backlash X_{BLk} of the k-th backlash portion BLₖ at the timing when the position deviation DIF increases rapidly; i.e., at the timing when the sign of the k-th load-side transmission torque τ_{Lk} changes. More generally, the compensation value X_{BLck} corresponding to the k-th backlash portion BLₖ is given by Equation 8.

$${X}_{B L c k} = \{ \begin{matrix}{X}_{B L k} & ( {τ}_{L k} > 0 ) \\ 0 & ( {τ}_{L k} \leq 0 )\end{matrix} \qquad Equation 8$$

In addition, the backlash compensation value X_{BLc} to be added to the position command value X is a sum of the compensation values X_{BLck} of the plurality of backlash portions BLₖ. That is, the backlash compensation value X_{BLc} is given by Equation 9.

$${X}_{B L c} = {X}_{BLc 1} + {X}_{BLc 2} + … + {X}_{BLcn} \qquad Equation 9$$

As is clear from the above description, in order to calculate the backlash compensation value X_{BLc}, it is necessary to know the sign (i.e., positive or negative) of the load-side transmission torque τ_{Lk} for each of the plurality of backlash portions BLₖ. However, in order to know the sign of the load-side transmission torque τ_{Lk}, it is necessary to know the value of the coefficient Mₖ in Equation 4. The coefficient Mₖ is the inertial moment from the corresponding backlash portion BLₖ to the load end 104, as shown in Equation 5, and serves as a coefficient for reverse detection of the load-side transmission torque τ_{Lk}.

In order to find the coefficient Mₖ, in this example, before normal operation of the target plant 100 is performed, temporary operation of the target plant 100 is performed using the position command value X of Equation 1 for a sinusoidal motion, with the backlash compensation value X_{BLc} set to 0. In this case, as described above, the position deviation DIF increases rapidly at the timing when the sign of the load-side transmission torque τ_{Lk} changes, that is, at the angles θ₁, θ₂, . . . , θₙ.

Here, the load-side transmission torque τ_{L1} at angle θ₁ is equal to the load-side transmission torque τ_{Lk} at angle θₖ. When the acceleration command values A at angles θ₁ and θₖ are denoted as A₁ and Aₖ, respectively, the following Equation 10 is satisfied.

$${M}_{1} * {A}_{1} + {τ}_{F} = {M}_{k} * {A}_{k} + {τ}_{F} {M}_{1} * {A}_{1} = {M}_{k} * {A}_{k} \qquad Equation 10$$

Furthermore, because the acceleration command value A is the value obtained by differentiating the position command value X=X₀+R₀*sin(θ) twice, A can be calculated as A=−R₀ω₀²·sin(ω₀t)=−R₀ω₀²·sin(θ). Furthermore, because M₁ is the total inertial moment J_{L}, Equation 10 can be converted to Equation 11.

$${J}_{L} * ( - {R}_{0} {ω}_{0}^{2} \cdot sin ( {θ}_{1} ) ) = {M}_{k} * ( - {R}_{0} {ω}_{0}^{2} \cdot sin ( {θ}_{k} ) ) {M}_{k} = ( sin {θ}_{1} / sin {θ}_{k} ) * {J}_{L} \qquad Equation 11$$

As is clear from Equation 11, the coefficient Mₖ can be calculated from the angle θₖ indicated by the position command value X when the position deviation DIF increases rapidly during the temporary operation, and the total inertial moment J_{L}. To this end, in this example, the temporary operation is performed prior to the normal operation of the target plant 100, to thereby determine the angle θₖ at which the position deviation DIF increases rapidly. The angle θₖ and the total inertial moment J_{L} are applied to Equation 11 to calculate the coefficient Mₖ corresponding to each of the plurality of backlash portions BLₖ. The calculated coefficients Mₖ are stored in a reverse detection unit 12 as coefficients for reverse detection. When the normal operation of the target plant 100 is performed, based on the coefficient Mₖ, the state of the sign of the load-side transmission torque τ_{Lk} and thus the backlash compensation value X_{BLc} are calculated.

Next, the configuration of the backlash compensation unit 21 constructed based on the above principle will be described. The backlash compensation unit 21 includes a coefficient calculation unit 10, the reverse detection unit 12, and a compensation value calculation unit 13, as shown in FIG. 1. When a calculation flag Ftun is ON, the coefficient calculation unit 10 performs the above calculation of the coefficient Mₖ. The calculation flag Ftun is also input to the compensation value calculation unit 13, and when the operation flag Ftun is ON, the compensation value calculation unit 13 outputs 0 as the backlash compensation value X_{BLc}. In other words, when the operation flag Ftun is ON, the backlash compensation is OFF.

The coefficient calculation unit 10 calculates the coefficients Mₖ based on the position command value X, the load position detection value X_{L}, and the total inertial moment J_{L}, which are input when Ftun is ON. Specifically, the coefficient calculation unit 10 calculates the position deviation DIF based on the position command value X and the load position detection value X_{L}. Then, at the timing when the position deviation DIF increases rapidly, the coefficient calculation unit 10 temporarily stores the angle θₖ indicated by the position command value X. The timing when the position deviation DIF increases rapidly may be determined, for example, based on a value obtained by time-differentiating the position deviation DIF. That is, the timing when this time differentiated value of the position deviation DIF exceeds a predetermined threshold value may be determined as the timing of the rapid increase in the position deviation DIF.

When the angles θₖ corresponding to the plurality of backlash portions BLₖ can be determined, the coefficient calculation unit 10 applies the angles θₖ and the total inertial moment J_{L} to Equation 11, to thereby calculate the coefficients Mₖ. Once the coefficients Mₖ corresponding to the plurality of backlash portions BLₖ are obtained, the coefficient calculation unit 10 outputs these coefficients Mₖ to the reverse detection unit 12. Furthermore, once the plurality of coefficients Mₖ are calculated, the calculation flag Ftun is switched from ON to OFF, and backlash compensation is turned ON. The switching of the operation flag Ftun may be automatically performed according to the calculation state in the coefficient calculation unit 10 or may be manually performed by the operator.

The reverse detection unit 12 calculates, based on the coefficient Mₖ, the sign state of the load-side transmission torque τ_{Lk} at each of the plurality of backlash portions BLₖ. Specifically, the reverse detection unit 12 receives, as inputs, the velocity command value V obtained by differentiating the position command value X once, the acceleration command value A obtained by differentiating the position command value X twice, and the sliding friction torque τ_{F}. In the normal operation where backlash compensation is ON, the position command value X is not limited to a command for a sinusoidal motion, and any position command value X for various motions may be input. The reverse detection unit 12 calculates the load-side transmission torque τ_{Lk} for each of the backlash portions BLₖ based on Equation 4. The reverse detection unit 12 then outputs a discrimination signal SNₖ=sgn(τ_{Lk}) obtained by applying a sign function to the resulting load-side transmission torque τ_{Lk}, to the compensation value calculation unit 13. As described above, the sign function sgn(i) is a function that outputs 1 when the argument i is positive, outputs −1 when the argument i is negative, and outputs 0 when the argument i is 0.

The compensation value calculation unit 13 outputs the backlash compensation value X_{BLc}. The compensation value calculation unit 13 stores in advance the amounts of backlash X_{BLk} for the plurality of backlash portions BLₖ. Here, as described above, when the calculation flag Ftun is ON, the compensation value calculation unit 13 sets X_{BLc}=0. On the other hand, when the operation flag Ftun is OFF, the compensation value calculation unit 13 calculates the backlash compensation value X_{BLc} according to Equations 8 and 9. In Equation 8, when SNₖ>0, X_{BLck}=X_{BLk}, and when SNₖ≤0, X_{BLck}=0.

The backlash compensation value X_{BLc} output from the compensation value calculation unit 13 is added to the position command value X, to thereby form a compensated position command value X_{c}. A velocity feedforward amount V_{fc} is then calculated based on this compensated position command value X_{c}, and as a result, the velocity feedforward amount V_{fc} includes a backlash velocity compensation value V_{BLc}. It is thus possible to maintain high position following performance even when there are a plurality of backlash portions BLₖ.

Furthermore, as shown in FIG. 1, in this example, the backlash compensation value X_{BLc} is added to a deviation (detection value deviation ΔX) between the load position detection value X_{L} and the motor position detection value Xₘ, to thereby calculate a compensated detection value deviation ΔX_{c}. The motor position detection value Xₘ and a value obtained by applying processing in the LPF processing unit 17 to the compensated detection value deviation ΔX_{c} are then added together to calculate a position feedback value X_{f}.

Here, when an output from the LPF processing unit 17 is expressed as α times an input (where 0≤α≤1) to the LPF processing unit 17, the position feedback value X_{f} can be expressed by Equation 12.

$${X}_{f} = α \{ ( {X}_{L} - {X}_{m} ) + {X}_{BLc} \} + {X}_{m} = {X}_{L} + ( 1 - α ) ( {X}_{m} - {X}_{L} ) + α * {X}_{B L c} \qquad Equation 12$$

Here, if (Xₘ−X_{L}) is equal to X_{BLc}, it is then possible to achieve a position control system in which both X_{c}=Xₘ and X_{c}=X_{L}+X_{BLc}, that is, X=X_{L}, are satisfied. This ensures high position following performance. Thus, even if a fully closed position control system is configured using, as an input, the compensated position command value X_{c}, which is the sum of the position command value X and the backlash compensation value X_{BLc}, the load position detection value X_{L} is not physically shifted by the amount of the backlash compensation value X_{BLc} depending on the direction of travel.

Furthermore, in this example, the backlash compensation value X_{BLc} is applied to the position command value X rather than the velocity command value. Response errors of a velocity control system can thus be compensated by response action of the position control system. As a result, for the backlash portions where operation occurs, following errors of the load position detection values X_{L} of the target plant 100 with respect to the position command values X can be reduced.

Next, another embodiment will be explained. In the above description, the timing of switching the compensation values X_{BLck} corresponding to the plurality of backlash portions BLₖ is determined based on the calculation results of the load-side transmission torque τ_{Lk} shown in Equation 4. However, it is not always necessary to calculate the load-side transmission torque τ_{Lk} to determine the timing of switching the compensation values X_{BLck}.

That is, by substituting Equations 3 and 11 into Equation 4, the load-side transmission torque τ_{Lk} can be converted to Equation 13.

$${τ}_{L K} = {J}_{L} ( sin {θ}_{1} / sin {θ}_{k} ) * A + {τ}_{FP} * sgn ( V ) \qquad Equation 13$$

Here, when the temporary operation of the target plant 100 is performed with the backlash compensation value X_{BLc} set to 0, the result is that the first load-side transmission torque τ_{L1}=0 at the angle θ₁ corresponding to the timing when transmission torque sign is reversed. The velocity command value V₁ at this angle θ₁ is V₁=R₀*ω₀*cos θ₁, and the acceleration command value A₁ is A₁=−R₀*ω₀²*sin θ₁. Substituting these equations into Equation 13 gives Equation 14.

$${τ}_{L 1} = {J}_{L} \frac{sin {θ}_{1}}{sin {θ}_{1}} ( - {R}_{0} {ω}_{0}^{2} sin {θ}_{1} ) + {τ}_{F P} sgn ( {R}_{0} {ω}_{0} cos {θ}_{1} ) = {J}_{L} ( - {R}_{0} {ω}_{0}^{2} sin {θ}_{1} ) + {τ}_{F P} sgn ( {ω}_{0} cos {θ}_{1} ) = 0 \qquad Equation 14$$

Furthermore, simplifying Equation 14 yields Equation 15.

$${J}_{L} sin {θ}_{1} = \frac{{τ}_{F P} sgn ( {ω}_{0} cos {θ}_{1} )}{{R}_{0} {ω}_{0}^{2}} \qquad Equation 15$$

Substituting this Equation 15 into Equation 13 and rearranging the result gives Equation 16.

$${τ}_{L k} = {τ}_{F P} ( \frac{A \times sgn ( {ω}_{0} cos {θ}_{1} )}{{R}_{0} {ω}_{0}^{2} \times sin {θ}_{k}} + sgn ( V ) ) \qquad Equation 16$$

Here, τ_{FP} is a predetermined fixed value, and its sign is always positive. Determining if the load-side transmission torque τ_{Lk} is positive or negative is therefore equivalent to determining if the determination parameter r_{Lk} shown in Equation 17 is positive or negative.

$${r}_{L k} = \frac{A \times sgn ( {ω}_{0} cos {θ}_{1} )}{{R}_{0} {ω}_{0}^{2} \times sin {θ}_{k}} + sgn ( V ) \qquad Equation 17$$

Here, Aₖ=−R₀*ω₀²*sin θₖ, and from FIG. 4, sgn(ω₀ cos θ₁)=sgn(V₁)=sgn(Vₖ). Substituting these into Equation 17 and rearranging the result gives Equation 18.

$${r}_{L k} = - \frac{A \times sgn ( {V}_{k} )}{{A}_{k}} + sgn ( V ) \qquad Equation 18$$

The timing at which positive and negative of the determination parameter r_{Lk} in this Equation 18 is reversed may be regarded as the timing at which positive and negative of the load-side transmission torque τ_{Lk} of each of the plurality of backlash portions BLₖ is reversed.

In this case, the coefficient calculation unit 10 calculates a coefficient Nₖ shown in Equation 19 and outputs the result to the reverse detection unit 12 as a coefficient for reverse detection.

$${N}_{k} = sgn ( {V}_{k} ) / {A}_{k} \qquad Equation 19$$

In addition, the reverse detection unit 12 calculates the determination parameter r_{Lk} in accordance with Equation 18. The reverse detection unit 12 also applies a sign function to this determination parameter r_{Lk} and outputs the result as a discrimination signal SNₖ=sgn(r_{Lk}). The compensation value calculation unit 13 changes the backlash compensation value X_{BLc} in accordance with the discrimination signal SNₖ.

Even in this case, it is possible to accurately determine the timing when the load-side transmission torque τ_{Lk} is reversed and thus increase or decrease the backlash compensation value X_{BLc} at an appropriate timing. As a result, even when there are the plurality of backlash portions BLₖ, high position following performance can be maintained.

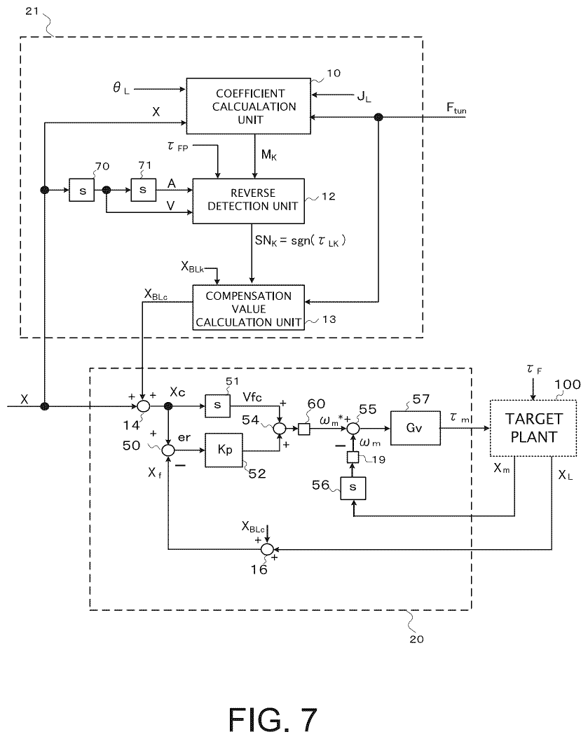

The configurations described above are merely examples, and any other configurations may be adopted so long as they satisfy the configuration of Claim 1. For example, the number of backlash portions BLₖ is not particularly limited so long as it is two or more. The process of calculating the position feedback value X_{f} may also be changed. For example, although, in the example of FIG. 1, the position feedback value X_{f} is obtained by adding and subtracting the motor position detection value Xₘ, the position feedback value X_{f} may not have the motor position detection value Xₘ as an input, as shown in FIG. 7.

### REFERENCE SIGNS LIST

10 coefficient calculation unit, 12 reverse detection unit, 13 compensation value calculation unit, 17 LPF processing unit, 19, 60 converter, 20 position control loop unit, 21 backlash compensation unit, 50, 55 subtracter, 51, 56 differentiator, 52 position error amplifier, 54 adder, 57 velocity error amplifier, 100 target plant, 102 motor, 104 load end, 110 torque transmission path, 120 current control unit, A acceleration command value, BL backlash portion, DIF position deviation, Ftun calculation flag, IN input terminal, J_{L} total inertial moment, J_{Lk} k-th partial inertial moment, Jₘ motor inertial moment, Mₖ, Nₖ coefficient, OUT_{N} output terminal, OUT_{P} output terminal, SNₖ discrimination signal, X position command value, X_{BLc} backlash compensation value, X_{BLk} amount of backlash, X_{L} load position detection value, X_{c} compensated position command value, X_{f} position feedback value, Xₘ motor position detection value, τ_{F} sliding friction torque, τ_{Lk} k-th load-side transmission torque, τₘ torque command value.

1. A position control device for a target plant in which a motor and a load end are connected via a torque transmission path having a plurality of backlash portions, the position control device comprising:
a coefficient calculation unit that
performs temporary operation of the target plant so as to reverse a direction of travel of the target plant with backlash compensation turned off, and
calculates a coefficient for reverse detection for each of the plurality of backlash portions, based on a position command value at a timing when a position deviation between a position detection value at the load end and the position command value increases rapidly, or based on a velocity command value and acceleration command value at the timing when the position deviation increases rapidly;
a reverse detection unit that
operates the target plant with the backlash compensation turned on, and
detects a timing when a load-side transmission torque is reversed for each of the plurality of backlash portions, based on the coefficient for reverse detection, the position command value, and a moment of inertia of the entire load;
a compensation value calculation unit that increases or decreases a backlash compensation value at the timing when the load-side transmission torque is reversed; and
a position control loop unit that controls a position of the motor such that the position detection value at the load end becomes a position command value compensated with the backlash compensation value.

2. The position control device according to claim 1, wherein the compensation value calculation unit adds or subtracts the amount of backlash of the k-th backlash portion from the motor, to or from a current backlash compensation value at a timing when the load-side transmission torque is reversed at the k-th backlash portion.

3. The position control device according to claim 2, wherein
the position control loop unit controls the position of the motor such that an absolute value of a position error that is a difference between the compensated position command value and a position feedback value becomes smaller, and
the position feedback value includes a sum of the position detection value at the load end and the backlash compensation value.

4. The position control device according to claim 1, wherein
the position command value in the temporary operation indicates a sinusoidal waveform represented by X=X₀+R₀*sin θ, and
the coefficient calculation unit calculates a coefficient Mₖ corresponding to the k-th backlash portion from the motor, based on Mₖ=(sin θ₁/sin θₖ)*J_{L}, where θₖ is θ obtained when the position deviation increases rapidly due to the k-th backlash portion, and J_{L} is the moment of inertia of the entire load.

5. The position control device according to claim 4, wherein the compensation value calculation unit calculates the load-side transmission torque in the k-th backlash portion τ_{Lk} based on the equation τ_{Lk}=Mₖ*A+τ_{F}, where τ_{Lk} is the load-side transmission torque in the k-th backlash portion, τ_{F} is a sliding friction torque, and A is an acceleration command value.

6. The position control device according to claim 1, wherein
the position command value in the temporary operation indicates a sinusoidal waveform represented by X=X₀+R₀*sin θ, and
the coefficient calculation unit calculates a coefficient Nₖ corresponding to the k-th backlash portion from the motor, based on the equation Nₖ=sgn(Vₖ)/Aₖ, where Aₖ is an acceleration command value when the position deviation increases rapidly due to the k-th backlash portion.

7. The position control device according to claim 6, wherein the compensation value calculation unit
calculates a determination parameter r_{Lk} based on the equation r_{Lk}=−A*Nₖ+sgn(V), where V is a velocity command value, A is an acceleration command value, and sgn is a sign function and
detects a timing when positive and negative of the determination parameter r_{Lk} is reversed as a timing when the load-side transmission torque is reversed at the k-th backlash portion.
